(19) United States
(12) Patent Application Publication
(10) Pub. No.: US 2013/0011569 A1
(43) Pub. Date: Jan. 10, 2013

(54) METHOD AND DEVICE FOR ARC SPRAYING

(76) Inventors: Jochen Schein, Munich (DE); Peter Heinrich, Germering (DE); Werner Krömmer, Landshut (DE)

(21) Appl. No.: 13/329,838

(22) Filed: Dec. 19, 2011

(30) Foreign Application Priority Data
Dec. 23, 2010 (DE) 102010064133.2
Apr. 21, 2011 (EP) 11003382.6

(51) Int. Cl. C23C 4/12; B05B 7/16

(52) U.S. Cl. 427/446; 392/307; 219/383; 427/580

(57) ABSTRACT

A method for arc spraying in which at least one wire-shaped spray filler material is melted in an arc by means of electric current and atomised by means of an atomising gas flow and applied in the form of a particle stream onto a workpiece, at least one wire-shaped spray filler material being preheated before the melting in the arc.

### CROSS REFERENCE TO RELATED APPLICATIONS

This application claims priority from German Patent Application 102010064133.2 filed Dec. 23, 2010 and European Patent Application 11003382.6 filed Apr. 21, 2011.

### BACKGROUND OF THE INVENTION

The present invention relates to a method for arc spraying, in which at least one wire-shaped spray filler material is melted in an arc by means of electric current and atomised by means of an atomising gas flow and applied in the form of a particle stream onto a workpiece, as well as a corresponding device.

Arc spraying is a thermal spraying method in which a wire-shaped spray filler material is melted by means of an electric current, using which an arc is created. A corresponding device is described e.g. in U.S. Pat. No. 2,982,845 A.

To this end, conventionally two electrically conductive metallic wires are used, which are continuously fused as electrodes, so-called one wire methods are likewise known however. A voltage of usually 15 to 50 V is applied to the wires, which are guided towards one another at an angle with a continuously reducing spacing by means of a feed apparatus and are conductively connected to a current source. In the event of a sufficiently small spacing of the wire ends from one another, an arc ignites. An atomising gas flow detaches the melt from the wire ends and accelerates the same in the form of a particle stream of the finest droplets onto a workpiece to be coated. The size and shape of the droplets can be set by means of the choice of the respective atomisation conditions. Generally, high flow rates of the atomising gas used lead to fine particles which naturally impact upon the workpiece at high speed.

The application performance achieved with conventional systems is approximately 8 to 20 kg/h and the particle speed is approximately 150 m/s. The spray filler material is melted with a thermal energy of approximately 4000° C. Conventionally produced layers have a thickness of 0.2 to 20 mm. Whilst in conventional systems, wires with a diameter between 1.6 and 3.2 mm are used, in high-performance systems, wires of up to 4.8 mm are used. The temperature of the arc far exceeds the melting temperature of the spray filler material. The droplets overheated in this manner can undergo metallurgical reactions with the workpiece surface at the point of impact or lead to the formation of diffusion zones. As a result, particularly in the case of the use of relatively large droplets, a particularly good adhesion and cohesion of the layer can be achieved.

In this context, it is furthermore known to heat the atomising gas flow used. Thus, EP 0 386 427 A2 discloses an arc spraying system with two separately controllable nozzles which can in each case create supersonic flows. Highly-compressed air, inert gases, active gases and also gas mixtures can be used as atomising gas. The preheating is used for increasing the flow speed of the atomising gas. It preferably takes place by means of electrically heated heat exchangers. As a result, the capacity for expansion and thus the discharge speed of the atomising gas is increased as a consequence of the volume increase connected with the preheating and a finer atomisation is achieved. Accordingly, it should be possible to achieve a substantial increase of the speed of the spray particles even in the case of a very large electrical power consumption of the spray gun.

The direct usage of the electrical energy causes a particularly good efficiency of the arc spraying technology. On account of the process, the selection of the spray filler material is limited to electrically conductive materials which can be prepared as wire. This limitation can however be overcome to some extent by using cored wires (fluxcored wires). For example, carbide and/or ceramic components can also hereby be sprayed in order to produce hard material layers. Arc spraying is particularly suitable for coating large-area parts. The fields of use comprise inter alia, corrosion protection, wear protection, the production or coating of sliding bearings and the “saving” of improperly processed machine parts.

In arc spraying, problems occur due to the fact that the melting and fusing behaviour of the two wires guided towards one another, which are connected as anode and cathode in each case, is different. This leads to a different droplet formation which is difficult to control and, as a result, to a reduction of the quality of a corresponding coating.

There is therefore a requirement for improvements in arc spraying.

### SUMMARY OF THE INVENTION

Against this background, the present invention suggests a method for arc spraying, in which at least one wire-shaped spray filler material is melted in an arc by means of electric current and atomised by means of an atomising gas flow and applied in the form of a particle stream onto a workpiece, as well as a corresponding device with the features of the independent patent claims. Preferred embodiments are the subject matter of the subclaims and also the following description.

According to the invention, a fusing behaviour of one or a plurality of spray filler materials is improved during arc spraying in that at least one of the wire-shaped spray filler materials is preheated before the melting in the arc. As it was possible to discover according to the invention, an increased melting rate is achieved by means of this preheating of the filler material.

A fusing process can be stabilised by means of a preheated spray filler material, which has reproducible results during arc spraying as a consequence. A spray filler material melted by means of an arc can be atomised better and an increase of the particle speed can be effected for example on account of changed viscosity properties. The advantages achieved according to the invention furthermore contain a significant saving of energy and a processing of higher melting materials (spray filler materials) is enabled, as a relatively large heat quantity (namely that of the preheating in addition to that of the arc) can be introduced by means of the preheating. In particular, the formation of spatters can be reduced. Spatters here means relatively large portions of detached wire material, which are created by short circuits and which are then also sprayed in an uncontrolled manner, that is to say with non-settable speed, temperature and size, and then cause layer defects. Furthermore, the fusing process can be stabilised as a whole by means of the preheating. More than in the case of a known heating of an atomising gas flow, a heating can take place on a wire-by-wire basis. This is particularly advantageous in the case of two-wire systems.

With particular advantage, in the context of the method according to the invention, at least one wire-shaped spray filler material is preheated to a temperature which lies between room temperature and a solidus temperature of the spray filler material. As a result, the maximum heat can be introduced into a corresponding spray filler material and at the same time a handling of a corresponding wire-shaped material in a spray device (for example by means of a feed apparatus) can be ensured. With particular advantage, in the context of the method according to the invention, the atomising gas flow is preheated to a temperature which lies between room temperature and 1000° C. In particular, the maximum heat can be introduced.

Further advantages can be achieved if the atomising gas flow is additionally preheated. As a result, as already mentioned at the beginning, its speed can be increased and/or the total energy quantity in the system can be increased further. The increased speed is in particular very advantageous if an influencing, in particular an influencing on a wire-by-wire basis, of the corresponding material properties has been carried out. A heating of wire and atomising gas flow may thus provide an above-average value added. It can likewise take place by means of the below mentioned heating apparatuses.

With particular advantage, at least one wire-shaped spray filler material or/and the atomising gas flow is preheated to a temperature which is selected as a function of a material composition, a material quantity and/or a feed rate of the spray filler material. On the basis of a process of this type, changing wire diameters or material compositions can be taken into account with particular advantage. In a corresponding manner, important advantages can be achieved in that at least one wire-shaped filler material and/or the atomising gas flow is preheated to a temperature which is selected as a function of a composition and/or a volume flow of the atomising gas flow. As mentioned, the size of the droplets which form in particular is influenced by means of a speed of the atomising gas flow. If a temperature is then additionally set as a function of an atomising gas flow, a defined droplet size and/or speed can hereby be achieved.

With particular advantage, at least one wire-shaped spray filler material or/and the atomising gas flow is preheated by means of induction, by means of a plasma and/or by means of a flame, in particular by means of a fuel gas oxygen flame. The heating by means of a plasma offers the particular advantage, in the case of a wire heating, that the surface of the wires used here can also be cleaned of impurities, oxidation products and the like, so that reduced requirements have to be placed on the purity of the wires and/or the storage conditions thereof. The method therefore becomes simpler and more cost effective.

Also a heating apparatus which contains an electrical heater and through which the wire-shaped material is guided or through which or past which flows the atomising gas flow, is advantageous for preheating. Also conceivable is the preheating of the wire-shaped filler material by means of the atomising gas flow, which for its part can be heated to suitable temperatures, or the preheating of the atomising gas flow by means of a preheating apparatus for a wire-shaped spray filler material, which for its part can be preheated before the melting in the arc. Wire-shaped spray filler material and atomising gas can also be preheated independently of one another and/or by means of a common preheating apparatus. Corresponding methods are known to the person skilled in the art from the prior art, which methods overall ensure a particularly efficient and defined introduction of heat into materials. With particular advantage, the method according to the invention can then be used if two wire-shaped spray filler materials are used during arc spraying. These two wire-shaped spray filler materials can be preheated to the same or different temperatures before the melting in the arc, so that for example, an identical fusing rate of two different wire materials is achieved. As mentioned, the method according to the invention can also be used in the case of other arc spraying technologies, for example one-wire, vacuum or vacuum one-wire arc spraying. With particular advantage, the method according to the invention can be used if an atomising gas flow composed of gaseous components is used during arc spraying. These may for example be nitrogen, argon, oxygen, hydrogen, helium and mixtures thereof in different proportions. As a result, e.g. the thermal conductivity and/or the viscosity of the atomising gas flow can be set in a targeted manner. At least one of the components can then be preheated, separately if appropriate, and used for setting a total heat.

With respect to the device for arc spraying provided according to the invention, reference may explicitly be made to the features and advantages mentioned on the part of the method. In particular, a device of this type has at least one preheating apparatus, which is provided for preheating at least one wire-shaped spray filler material before the melting in the arc, and/or at least preheating apparatus, which is provided for preheating the atomising gas flow before the atomisation of the spray filler material. This can advantageously be constructed as a burner for creating a burner flame. In particular, here a fuel gas oxygen burner, as is known from the prior art, can be used. With particular advantage, a preheating apparatus can also be constructed as induction heater with an inductor with induction loop or coil. A high-frequency (HF) induction heater of a known type can for example be used for example for heating one or both wires and/or for the indirect heating of the atomising gas flow, alone or in addition to flame heating. In HF induction heaters of this type, a single- or multiple-coil working coil (inductor) is provided, through which an alternating current of high frequency flows. In the surroundings of the coil, an electromagnetic alternating field is thereby generated. If a conductor is introduced into this electromagnetic alternating field, a voltage is induced in this conductor, which generates an alternating current. In accordance with Joule's Law, according to Q=I²×R×t (I: current intensity, R: resistance, t: time), heat is generated as a result in the surface regions of the conductor, through which current flows. To cool the coil, one cooling apparatus is advantageously provided, for example water cooling. The HF induction heater is advantageously galvanically separated from the remaining operation components, in order to ensure the greatest possible safety. Provision can be made to provide exchangeable inductor elements, for example with different internal diameters, in order to ensure adaptability to different wire materials. Depending on the heat output to be introduced and in accordance with the spatial requirements, a single induction loop or a multiple-coil inductor can be provided.

In particular, a preheating apparatus can also be provided, which is set up as a plasma source. Plasma sources, for example plasma burners, are known from the prior art and ensure a particularly efficient introduction of a large energy quantity. In a simple advantageous configuration, the preheating apparatus comprises an electrical heater and is constructed in such a manner that the wire-shaped filler material can be passed through it or that atomising gas can flow through it or along it, in order to become preheated. As mentioned, a plasma allows a cleaning of the surface of the filler material. For the case that a wire-shaped spray filler material and the atomising gas is preheated, it makes sense to use one and the same preheating apparatus (for example with an electrical heater), through which the wire and the gas are guided. Further advantages and configurations of the invention result from the description and the appended drawing.

It is to be understood that the previously mentioned features and the features which are still to be mentioned in the following, can be used not only in the respectively specified combination, but also in other combinations or alone, without departing from the context of the present invention.

### BRIEF DESCRIPTION OF THE DRAWINGS

The invention is schematically illustrated in the drawing on the basis of an exemplary embodiment and is described in detail in the following, with reference to the drawing.

FIG. 1 shows a device for arc spraying according to the prior art in a schematic illustration.

FIG. 2 shows a device for arc spraying according to a particularly preferred embodiment of the invention in a schematic illustration.

FIG. 3 shows a device for arc spraying according to a particularly preferred embodiment of the invention in a schematic illustration.

FIG. 4 shows a device for arc spraying according to the prior art in a partial sectional illustration.

FIG. 5 shows a device for arc spraying according to a particularly preferred embodiment of the invention in a partial sectional illustration.

FIG. 6 shows a device for arc spraying according to a particularly preferred embodiment of the invention in a partial sectional illustration.

In the figures, the same or comparable elements are specified with identical reference numbers and are not explained repeatedly for the sake of clarity.

### DETAILED DESCRIPTION OF THE INVENTION

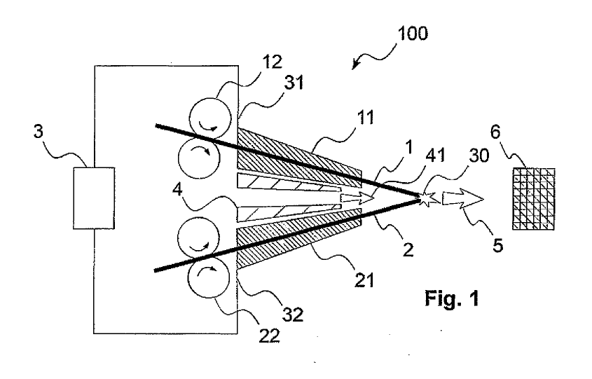

A device 100 for arc spraying according to the prior art is schematically illustrated in FIG. 1.

In the device 100, a first 1 and a second 2 wire-shaped spray filler material are guided towards one another by means of a wire guide 11, 21 in each case. To feed the wire-shaped spray filler materials 1, 2 towards one another, feed apparatuses 12, 22 are provided in the form of rollers or rolls rotating in the direction of the arrow.

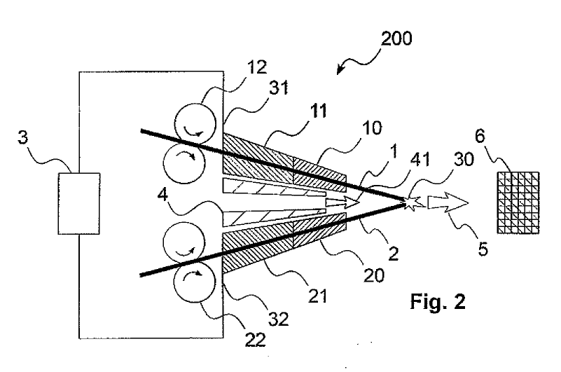

Further, a current source 3 is provided, which is connected to the wire guides 11, 21 via electrical connections 31, 32 for loading the wire-shaped spray filler materials 1, 2. In a region in which the wire-shaped spray filler materials have a sufficiently small spacing, an arc 30 forms, by means of which the material of the wire-shaped spray filler materials 1, 2 is melted. An atomising gas nozzle 4 is provided, by means of which an atomising gas flow 41 is provided and guided. The atomising gas flow 41 effects an atomisation of the wire filler materials 1, 2 melted in the arc 30 and a formation of a particle stream 5 which can be directed onto a workpiece 6. FIG. 2 shows a device 200 for arc spraying according to a particularly preferred embodiment of the invention in a schematic illustration. The device 200 has the essential elements of the device 100 from FIG. 1. In addition, however, preheating apparatuses 10, 20 for the wire-shaped spray filler materials 1, 2 are provided, which preferably surround the wire-shaped spray filler materials, for example in the form of a wire guide distally to the wire guides 11, 21. As mentioned, the preheating apparatuses 10, 20 can be set up as electrical heaters, burners, inductors and/or plasma sources. The preheating apparatuses 10, 20 can be configured identically or differently and/or be based on the same or different preheating principles. The wire-shaped spray filler material 1, 2 is already preheated by means of the preheating apparatuses 10, 20 before the arc 30 is achieved. Provision may also be made for the preheating apparatuses to be provided at another position which enables an effective preheating which advantageously does not conflict with the application of current via current source 3. In particular, the preheating apparatuses 10, 20 can be provided on the feed apparatus side of the wire guides 11, 21.

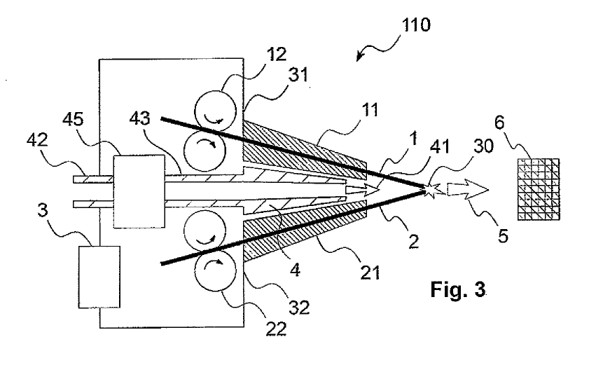

FIG. 3 shows a further device 200 for arc spraying according to a particularly preferred embodiment of the invention in a schematic illustration. For the sake of clarity, the illustration of the preheating apparatuses for the spray filler materials 1, 2 has been dispensed with, however. The device 110 has the essential elements of the device 100 from FIG. 1. In addition, however, a preheating apparatus 45 is provided for the atomising gas flow 41, which preferably coaxially surrounds a supply line for the atomising gas flow 41. As mentioned, the preheating apparatus 45 can be set up as electrical heater, burner, inductor and/or plasma source. A plurality of preheating apparatuses 45 can be provided, be configured identically or differently and/or be based on the same or different preheating principles. The atomising gas flow 41 is already preheated by means of the preheating apparatus 45 before the arc 30 is achieved. Provision may also be made for the preheating apparatus to be provided at another position which enables an effective preheating which advantageously does not conflict with the application of current via current source 3. In particular, the preheating apparatus 45 can be provided proximally to an atomising gas nozzle 4.

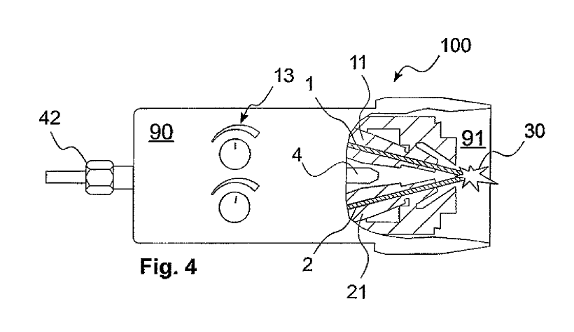

FIG. 4 shows a device 100 for arc spraying according to the prior art in a partial sectional illustration. The device 100 has a housing 90 which is illustrated partially open in a front region 91. Wire-shaped spray filler materials 1, 2 are guided by means of a wire guide 11, 21 in each case. A wire feed apparatus (like the wire feed apparatuses 12, 22) is not illustrated here. Setting means 13 are used to control the feed speed, which can for example be arranged on the housing 90 or at another position. An atomising gas nozzle 4 is provided, which is fed via an atomising gas connection 42 and is set up for forming an atomising gas flow 41 and a particle stream 5 (both not illustrated here). An arc 30 forms between the wire-shaped spray filler materials 1, 2.

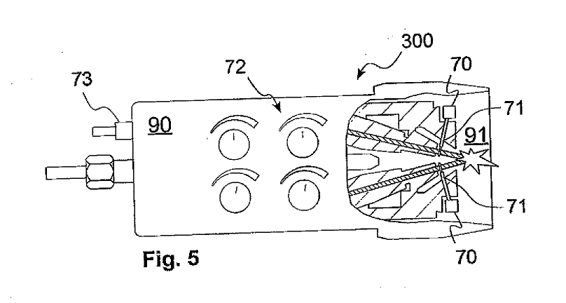

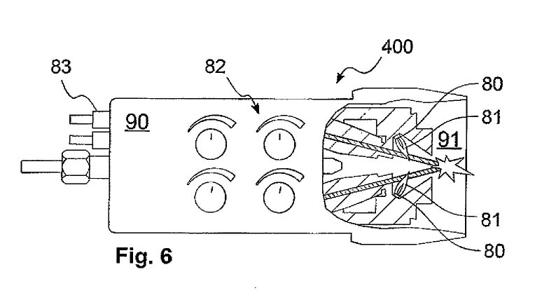

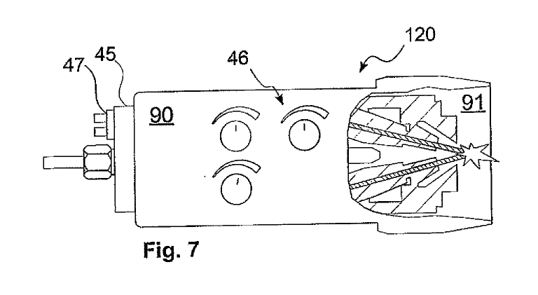

A device according to a particularly preferred embodiment of the invention is illustrated in FIG. 5 in a partial sectional view. The device 300 has the essential elements of the device 100 from FIG. 4. In addition, in the case of device 300, a preheating apparatus is provided for each wire filler material 1, 2 in the form of an inductor 70 with an induction loop or coil 71 in each case. The inductors 70 are set up for loading the induction loops or coils 71 with high-frequency energy, as mentioned previously. The same are preheated by means of a corresponding thermal loading of the wire filler materials 1, 2 before the arc 30 is achieved. The heating can be controlled by means of control apparatuses 72 which can be provided on the housing 90. In addition, a line 73 is provided for loading the respective inductors 70. In FIG. 6, a device 400 for arc spraying according to a particularly preferred embodiment of the invention is illustrated in a partial sectional illustration. Like the device 300, device 400 has the essential features of the device 100 from FIG. 4. In device 400, preheating apparatuses are provided, which in each case are constructed as burners 80 for creating a burner flame 81. As before, a preheating periphery can be set up using the burners 80 by means of a control apparatus 82. To supply the burners 80, supply lines are provided for fuel gas and/or oxygen for example.

Although in the previous figures, identical preheating apparatuses were illustrated individually in each case for both wire filler materials 1, 2, it may be understood that provision can also in particular be made to load different wire filler materials 1, 2 with different and/or a plurality of and/or common preheating apparatuses 10, 20. For example, provision may be made to provide a preheating by means of a burner 80 in a first step and a preheating by means of an inductor 70 in a second step. A device according to a particularly preferred embodiment of the invention is also illustrated in FIG. 7. The device 120 has the essential elements of the device 100 from FIG. 4. For the sake of clarity, the illustration of the preheating apparatuses for the spray filler materials 1, 2 has been dispensed with, however. In addition, in the case of device 120, a preheating apparatus 45 is provided for the atomising gas flow 41, which is provided by means of supply lines 47 via a nozzle 4. The heating can be controlled via a control apparatus 46 which can be provided on the housing 90. Although an individual preheating apparatus 45 was specified in each case in the context of the preceding figures, it may be understood that provision may in particular also be made to provide a plurality of and/or different preheating apparatuses 45 and/or to heat wire filler materials 1, 2 with different and/or a plurality of and/or common preheating apparatuses 45. For example, provision may be made to provide a preheating by means of a burner in a first step and a preheating by means of an inductor in a second step.

What we claim is:

1. A method for arc spraying, in which at least one wire-shaped spray filler material is melted in an arc by means of electric current and atomised by means of an atomising gas flow and applied in the form of a particle stream onto a workpiece, characterized in that at least one wire-shaped spray filler material is preheated before the melting in the arc.

2. The method according to claim 1, in which at least one wire-shaped spray filler material is preheated to a temperature between room temperature and a solidus temperature of the spray filler material.

3. The method according to claim 1, in which furthermore, the atomising gas flow is preheated before the atomisation of the at least one wire-shaped spray filler material.

4. The method according to claim 3, in which the atomising gas flow is preheated to a temperature between room temperature and 1000° C.

5. The method according to claim 1, in which at least one wire-shaped spray filler material is preheated to a temperature which is selected as a function of a material composition, a material quantity and/or a feed rate of the spray filler material.

6. The method according to claim 1, in which at least one wire-shaped spray filler material is preheated to a temperature which is selected as a function selected from the group consisting of a composition and a volume flow of the atomising gas flow.

7. The method according to claim 1, in which at least one wire-shaped spray filler material is preheated by a means selected from the group consisting of by means of induction, by means of an electrical heating apparatus, by means of a plasma and by means of a flame.

8. The method according to claim 7, in which at least one wire-shaped spray filler material is preheated by means of a fuel gas oxygen flame and by means of a heated atomising gas flow.

9. The method according to claim 1, in which at least two wire-shaped spray filler materials are used and are preheated to the same or different temperatures before the melting in the arc.

10. The method according to claim 1, in which an atomising gas flow made up of gaseous components, selected from the group consisting of nitrogen, argon, oxygen, hydrogen, helium and mixtures thereof in different proportions, is used.

11. The method according to claim 10, in which at least one of the gaseous components of the atomising gas flow is preheated.

12. A device for arc spraying which is set up for carrying out a method according to claim 1, with at least one preheating apparatus which is provided for preheating at least one wire-shaped spray filler material before the melting in the arc.

13. The device according to claim 12, in which at least one preheating apparatus is selected from the group consisting of a burner for creating a burner flame an inductor with an induction loop and/or induction coil a plasma source and an electrical heater.
